(19) United States
(12) Patent Application Publication
(10) Pub. No.: US 2022/0389738 A1
(43) Pub. Date: Dec. 8, 2022

(54) LOCK STRUCTURE AND METHOD OF PROTECTION

(71) Applicant: DAVID TRUFFET, MCDOWALL (AU)

(72) Inventor: DAVID TRUFFET, MCDOWALL (AU)

(21) Appl. No.: 17/833,610

(22) Filed: Jun. 6, 2022

(30) Foreign Application Priority Data
Jun. 7, 2021 (AU) 2021901691

(51) Int. Cl. E05B 27/00; E05B 15/16

(52) U.S. Cl. CPC E05B 27/0075; E05B 27/0007; E05B 27/0042; E05B 15/1614

(57) ABSTRACT

A pin tumbler lock has a body in which is rotatably housed a core assembly that includes first and second core portions that are rotatable relative to each other, the first core portion being coupled to a moveable cam operatively connected to a locking element external to the lock, and the second core portion including a keyway, there being a shaft extending from the core assembly into the lock body, and a pin stack including a driver pin and a key pin within the shaft, the stack being positionable under bias to engage the first and second core portions against independent rotation, wherein the pin stack is positionable in the presence of an object other than a correct key in the keyway to cause disengagement of the first core portion from the second core portion. The first and second core portions may be coaxially aligned.

### TECHNICAL FIELD

The present disclosure relates to tumbler-locks and the protection of such locks against attempts to tamper with them or open them without a matching or “correct” key.

### BACKGROUND TO THE DISCLOSURE

Tumbler locks are well-known as a category of locking devices used on openable closures such as doors. Pin tumblers are commonly employed in cylinder locks, but may also be encountered in tubular pin tumbler locks, known also as radial locks or ace locks.

The lock of the present disclosure is possessed of the main components in the conventional lock, which will be described below with reference to FIG. 1 (prior art), which is a set of schematic illustrations of the operation of a conventional known cylinder lock 10. As depicted in (a), the cylinder lock has a body 12, which is in the form of an outer casing 14 having a cylindrical axial bore 16 within. The key-receiving plug or core 18 is housed in the bore. The core has a front, or front end and a back, or back end. The front end is exposed at the front 28 of the body, which is where a key must necessarily be inserted to actuate the lock from a locked to an unlocked state. The core is held in place and prevented from being pulled out of the body from the front by means of a fastening at the end 32, which is distal from the front. This distal end defines the back of the lock and would normally face into a space to be secured by the closure to which the lock is fitted. Typically, the back of the core protrudes from the back of the lock so that it can be linked to the movable cam and bolting element. The fastening is commonly a C-clip or a set of threaded screws that are screwed into a threaded hole in the end of the core that protrudes from the body.

For the lock to open, the core must be caused to rotate relative to the casing or body, which is coupled to the movable closure to be opened. Less commonly, the lock may be fitted to the stationary frame within which the movable closure is mounted. The core is designed to be rotated with little difficulty and with minimal force being required when activated with an appropriately shaped key. We shall refer to such key as the “correct” key or “matching” key. The core may also be rotated by an attacker who does not have the correct key, applying known lock disruption techniques. The solution described in the present disclosure is intended to inhibit the application of at least some of these techniques, as will be described below.

U.S. Pat. No. 18,169 to Yale describes a now-traditional modern style pin tumbler lock, which includes a body containing a rotatable core occupying a bore within it, and a keyhole and keyway into the core for insertion of a key to turn the core. The core is held in place in the body by a set of paired pins, referred to as key pins and driver pins. Such pins are labelled in FIG. 1 with the numerals 20 and 22, respectively. The key and driver pins of each pair are axially aligned with a coiled spring to define a pin stack, located within tubular holes or pin stack shafts 24, which extend generally outwardly from the core axis into the body A key inserted into the keyway will make direct contact with the lower portions of the key pins that protrude from the pin stack shafts into the keyway. In each stack, the spring is located at the distal end of the bore, so that the driver pin lies between the spring and the key pin.

For clarity, a pin stack as referred to herein is a single instance of a key pin, driver pin and spring, associated to be contained at least partially within a cylindrical bore 24. For completeness, “the driver pin” may be a single standard driver pin, a security pin (such as a spool or hollow trap pin) or consist of two pins stacked one on top of the other, with either being a standard and/or a security pin.

Each shaft 24 within the core intersects with the keyway and, when the correct key is inserted, the key will move the pins in the pin stack within the relevant shaft into the desired location to allow the lock to open.

Typically, a lock may have five to seven pin stacks and a corresponding number of shafts in a single row 36. However, the number, orientation and positioning of the shafts containing the pin stacks can be varied in accordance with a trade-off between the level of desired security and the manufacturing cost thereof. The shafts typically include sections of slightly differing cross-sectional dimensions. Correspondingly aligned shaft sections 34 of substantially the same as, but slightly larger diameter than, core sections 25 extend from the core into the body. A small difference in diameters is advantageous to allow the driver pins when displaced radially away from the keyway to be arrested shortly past the shear line 38, which is located at the interface between the core and the body and thus where the core shaft sections 25 meet the body shaft sections 34. These features and their role will be discussed presently.

At distal end 32 of core 18 is a cam or lever (not shown), mechanically linked to a movable locking bolt (also not shown). Rotation of the core (ideally by means of the correct key) in relation to the body causes the cam to move.

The key pins differ in length from shaft to shaft, as shown in FIG. 1, and these differences prevent the lock from opening, unless the correct key is inserted into keyway 26 and turned. The keyway runs transversely in relation to the axial direction of the pin stacks, leading inwardly into the core from its outer or front end 28 at which the keyhole is located. The configuration of the correct key causes the pins to be raised to an interface at shear line 38 between the rotatable and stationary assemblies of the lock. <https://en.wikipedia.org/wiki/Pin_tumbler_lock> The key acts directly on the key pins. As shown in FIG. 1(b), when the correct key 30 is inserted into the keyway 26, the action of the key on the key pins causes them to exert radial outward force on the driver pins, urging them into the shafts 34 in the body against the resistance provided by springs 42.

The shape and configuration of the key and the lengths of the key pins combine to urge these pins individually radially outwards, until their distal ends align at the shear line, abutting the proximate ends of the driver pins.

The key pins of differing length are receivable into the shafts in the core. The body shafts are occupied by spring-loaded driver pins, which are biased by springs 42 towards the axis of the core so that in the absence of the correct key in the keyway, at least one of the driver pins extends across the shear line into the core, thereby preventing the core from being rotated in the body. The springs urge the key pins towards the core axis, so that they obstruct the keyway. When a correct key is inserted, it pushes the key pins and driver pins radially outwardly against the springs, so that the driver pins are fully received into the body and distal end of each key pin aligns with the shear line. The core is now able to rotate in the body and cause the cam to be activated so that it moves the bolt aside and allows the closure to open. The diameters of the body shaft sections 34, because of their difference, are caused not to align exactly with the core shafts, so that there is a slight discontinuity in the surfaces of the shafts where they interface, enough to allow the driver pins to be detained in the body shafts, as shown in FIG. 1(b). In FIG. 1(c), when key 30 is turned to the right as indicated by directional arrow K, the key pins, which are retained in the core shafts, are displaced out of alignment with the driver pins, which remain hung up in the body shafts, contained by the core surface. The core is now free to rotate, displacing the cam and linked locking bolt or alternative locking element.

When the key is returned to the rotational position in (b), the key pins realign with the driver pins and are subjected to radial bias towards the core axis again. When the key is withdrawn from the keyway, the springs push the key and driver pin pairs into position where the drive pins straddle the shear line and the key pins obstruct the keyway, thereby causing locking action on the cam.

A problem encountered with pin tumbler locks is that they are vulnerable to certain kinds of external attack, by persons intent on opening the lock by means other than use of the correct key. Common forms of attack include picking, bumping, impressioning and decoding, drilling, shearing, pulling or plug extraction and snapping. Picking, bumping and impressioning are three non-destructive methods that can be used to open a lock covertly. The other methods are commonly known as destructive methods and usually require a large amount of force to be exerted on the lock structure. More forceful methods may result in the destruction of the lock by the breaking of the fastening clip or screws that hold the core in the body. With enough force, methods of this kind inevitably succeed.

Pulling or extraction pulling or plug extraction, as described in U.S. Pat. No. 5,276,951, involves placing a hardened metal object in the keyway that can be as complex as a custom-made hook designed to engage with a known feature of the lock or its keyway or as basic as a self-tapping hardened screw that can be used on a wide variety of keyways. Once fixed in position, a pressure plate is usually placed over the face of the lock with a hole large enough for the core to be pulled through. Mechanical advantage is then used to apply pressure on the pressure plate and pulling force is exerted on the hook or screw inserted in the keyway. Such attacks are well known and devices to perform them are easily obtainable, allowing a low skilled attacker to gain rapid entry access to a wide verity of pin tumbler locks with little or no training.

Key impressioning or decoding attacks aim to construct a ‘correct’ key from information that can be deduced from the lock itself. Previously key impressioning attacks required significant skills but have been made simpler via devices such as “Lishie Pick/Decode” <https://www.genuinelishi.com/lishi_tool/nigh-vision-hon58r-3-in-1/> or <https://www.youtube.com/watch?v=ZCbb8ZfHsog> and advances in miniaturisation of camaras, for example the LockTech LTKSD <https://www.youtube.com/watch?v=DGdsUrAjp3k> and transducer disclosed in patent application publication US20150033861A1. Given the ready availability of these solutions and allowing for the inside of locks to be filmed and displayed on the attacker's mobile phone, these types of attacks need to be considered when evaluating the security of modern locks such as Kwikset SmartKey, disclosed in patent application publication US20120312127) locks.

A known device to improve security of pin tumbler locks is the use of security pins designed to frustrate picking attempts. Such pins are named after their shape characteristics, for example serrated, mushroom, barrel and spool, pin in pin, and Emhart.

A second known ‘improvement’ lies in the introduction of a third pin between the driver and key pin. When small, these are often referred to as ‘wafers’.

U.S. Pat. No. 3,349,588 describes the use of trap pins aimed as seizing the lock, should it be picked. These trap pins can either be hollow or have a narrower diameter than standard T-pins. A commercial implementation of the invention of this patent, known as “Segal's No. 8080 Hines Key System Cylinder” <https://www.youtube.com/watch?v=3g0-pxXD794>, suffered from having a highly distinctive external face. This allowed an attacker to obtain a matching lock on the open market and discover that the lock had three trap pins in cylinders 2,3 and 5, and that the arrangement in these cylinders involves a key pin, a standard wafer and a hollow trap pin.

A drawback of the invention described in the above patent is the predictability of the lock configuration. The patented lock itself provided no protection from key impressioning attacks, as impressioning starts with a blank key and progressively lowers the key pins until the highest shear line is met, so that an attacker would not need to know if trap pins were or were not present.

### Objects of the Disclosure

It is an object of the present disclosure is to address the shortcomings of the prior art and, in doing so, to provide pin tumbler lock in which vulnerabilities of prior similar locks are reduced.

The preceding discussion of the background to the present disclosure is intended to facilitate an understanding of the solution herein described. However, it should be appreciated that the discussion is not an acknowledgement or admission that any of the material referred to was part of the common general knowledge in the field at the priority date of the present application.

### Summary of Disclosure

According to a first aspect of this disclosure, there is provided a pin tumbler lock including a core assembly rotatably mounted within a lock body wherein the core assembly includes cooperating first and second portions having an interface between them, the first portion being linked to an external closure member and the second portion including a keyway.

The first and second portions may be mutually rotatable, meaning that each is able to rotate relative to the other.

The second portion may be partially nested within the first portion.

In an embodiment, the first and second core portions are coaxially aligned.

There may be an interface between the first and second portions through which a pin stack shaft passes, the pin stack including a key pin and a driver pin.

The key stack may include a spool element.

In an embodiment, the first and second portions become mechanically isolated when the interface between the key pin and the driver pin is in register with an interface between the first and second portions.

In a further embodiment, the lock may include a front plate from which the first portion is spaced.

The lock may include a front end defined by a front plate, behind which is located a protection barrier against drill attack, located in the body inward of the front end, the barrier being made of relatively harder material than the front plate.

The barrier may include hard metal spokes extending radially outward from the second portion to radially traverse the lock body.

The spokes may extend through radial bores formed in the lock body into a circumferential channel in the second core portion.

In a further embodiment, the barrier may include a hard metal plate extending radially outward from the second portion to radially traverse the lock body and surround the second portion.

Further, according to the disclosure, the lock may include a protection mechanism inhibiting axial extraction of the core assembly from the lock body.

The mechanism may include a ball bearing.

The ball bearing may be located between the lock body and the first portion.

In a further embodiment, the lock includes a lockout mechanism that when actuated isolates the first portion from the second portion.

The lockout mechanism is actuable by an object (other than the correct key) being inserted into the keyway, causing displacement of an end of a key pin into register with the interface between the first and second portion.

The lock may further include a pin stack shaft that traverses said interface between the first and second portions, and a pin stack displaceable within the shaft, said pin stack including a key pin and a driver pin abutting at an interface between them.

This disclosure further provides a pin tumbler lock having a lock body, a core assembly housed rotatably in the body and including first and second core portions that are rotatable relative to each other, the second core portion including a keyway, and the first core portion being coupled to a moveable cam operatively connected to a locking element external to the lock, a shaft extending from the core assembly to the lock body, and a pin stack including a driver pin and a key pin within the shaft, and positionable under bias to engage the first and second core portions against independent rotation, characterised in that the pin stack is positionable in the presence of an object other than a correct key in the keyway to cause disengagement of the first core portion from the second core portion.

The first and second core portions may be configured so that said object, when present, allows rotation of the second core portion relative to the first core portion without causing the cam and locking element to be displaced from locking condition.

In an embodiment, the second portion is sacrificial, and may include a controlled failure device. The controlled failure device may be configured to fail when subjected to a predetermined degree of force such as exerted by an attacker of the lock to either extract or shear the lock.

In an embodiment, the barrier extends generally radially to straddle at least one shear line.

The lock may further include a system for retaining the outer core within the bore. In an embodiment, the outer core retention system includes a bearing mechanism disposed in the bore between the outer core and the body.

The present disclosure provides further for a pin tumbler lock including:
a. a body having a bore extending therethrough,
b. a core assembly rotatably located in the bore, and
c. a connector that connects the core assembly to the body,
   i. the core including a first portion, a second portion and a coupling between said portions,
   ii. the first portion having a locking and unlocking function when linked to an external locking member,
   iii. the coupling being adapted for decoupling the first from the second portion in the event of the lock coming under attack, maintaining the locking function of the first portion.

The second portion may further include a keyway for receiving a key.

The present disclosure additionally extends to a method of limiting effectiveness of an attack on the integrity of a pin tumbler lock, the lock being of a type having a core assembly housed rotatably in a bore within a lock body and connected to a moveable cam, the method including:
a. Providing the core assembly in first and second portions, and
b. Allowing the first and second portions to be engaged when a correct key is used for operating the lock and to be disengaged when the lock is under attack.

The method may further allow sacrifice of the second portion when disengaged from the first portion,

Moreover, the present disclosure provides a method of manufacture of a pin tumbler lock for mitigating pin stack shaft alignment error, the method including:
a. Associating a core component for the lock with a lock body;
b. Forming a temporary lock assembly in which the associated core component and lock body are in operative relationship;
c. Temporarily securing the associated core component and lock body of the temporary lock assembly against relative movement;
d. While said associated component and body are temporarily secured, forming a pin stack shaft that extends from the body into the core component;
e. Dissembling the temporary assembly after formation of the shaft; and
f. Maintaining association of the dissembled core component and lock body once dissembled.

The method may further include causing the dissembled associated core component and lock body to undergo a conditioning treatment in preparation for their reassembly together into a single operative lock. The treatment step may include cleaning the body and the core component to remove unnecessary or extraneous matter or substances not required for operative functioning of the lock and not desirable for the marketable appearance of the finished product.

The method may include assembling the lock by aligning shaft sections within the respective associated and treated body and core component.

In an embodiment, the core component includes first and second core portions, the first portion being able to be selectively mechanically isolated from the second portion.

This disclosure extends further to providing a pin tumbler lock configured to lock and unlock a lockable item linked to a moveable cam mechanism, the lock including:
a. first and second core portions housed within a lock body and being movable relative to the body and to each other, the first core portion having a keyway and the second core portion being coupled to said cam mechanism;
b. a pin stack within a shaft extending from the keyway into the lock body, the stack being configured for engaging the second portion with the first portion so that they rotate in unison under action of a correct key and for disengaging the second from the first portion when an object other than the correct key is inserted in the keyway.

This disclosure further proposes a pin tumbler lock having a lock body, a core assembly housed rotatably in the body and including first and second core portions that are rotatable relative to each other, the second core portion including a keyway, and the first core portion being coupled to a moveable cam operatively connected to a locking element external to the lock, a shaft extending from the core assembly to the lock body, and a pin stack including a driver pin and a key pin within the shaft, and positionable under bias to engage the first and second core portions against independent rotation, characterised in that the pin stack is positionable in the presence of an object other than a correct key in the keyway to cause disengagement of the first core portion from the second core portion.

The second portion may be sacrificial, and may include a controlled failure device.

Furthermore, this disclosure provides a pin tumbler lock including a lock body, within which a core assembly that includes a keyway is operatively located and coupled to an exterior moveable cam element, and a barrier to drilling attack which extends radially from within the core assembly into the lock body, the barrier being made of a relatively harder substance than the lock body.

The barrier may include a plurality of rods or a plate.

The plate may include complemental sections locatable around the keyway.

In an embodiment, the core assembly has a surface with a circumferential groove from which the barrier radially extends located adjacent a front end of the lock body.

The core assembly may include first and second core portions, the second core portion being at least partially nested within the first core portion.

The groove may be located in the second core portion.

The barrier may straddle a shear line defined between the first and second core portions.

### BRIEF DESCRIPTION OF DRAWINGS

In order that the disclosure may be readily understood, and put into practical effect, reference will now be made to the accompanying figures. Thus:

FIG. 1 shows in schematic form a set of diagrams, in partially cutaway oblique views from the keyhole side (front), showing the operation of a conventional pin tumbler lock of the prior art. The illustrations were obtained from the online encyclopaedia, Wikipedia at <https://en.wikipedia.org/wiki/Pin_tumbler_lock>. Labeling of relevant components has been added.

FIG. 2 is an axial cross-sectional diagram showing first and second shear lines in a single pin tumbler lock embodiment according to this disclosure.

FIG. 3 is a schematic diagram of a pin tumbler lock in an alternative embodiment of the present disclosure, in partially cut-away views, with its outer casing removed, the views being (a) front elevation, (b) oblique front perspective partially cut away along a line extending from the vertical diameter of the inner core portion, (c) sectional side view of the cutaway of (b) with all but one pin stack not shown for simplicity of illustration, (d) rear oblique partially cut-away view along the line of the cutaway in (b) and (e) a side view partially cutaway as in (b) with the lock in (c) rotated about 90° in a clockwise direction when seen from the front end, compared with the views in (a), (b) and (c).

FIG. 4 presents perspective views from (a) rear, (b) front and (c) partially cut-away side sectional view taken along the diameter of the outer core portion, showing the inner and outer core portions of the embodiment of FIG. 3 when in uncoupled independently rotatable relationship.

FIG. 5 is a series of perspective and side views of the core portions of the lock of FIG. 3 when separated: Inner core portion (a) rear underside perspective showing keyway; (b) front top perspective showing bores for key pins; (c) rotated rear perspective of inner core portion being directed to the receiving cavity within the outer bore portion; (d) side elevation of the inner core portion; and (e) underside elevation of the inner core portion.

FIG. 6 is a series of views of the lock body of FIG. 3, with core portions removed to illustrate the interior: (a) front perspective, (b) front elevation; and (c) rear perspective.

FIG. 7 illustrates in schematic partially cut-away views a drill penetration barrier applied to the embodiment of FIG. 3: (a) front perspective; (b) front view; (c) rear elevation; (d) rear perspective; and (e) side elevation.

FIG. 8 illustrates in partially cut-away views a drill penetration barrier applied to the embodiment of FIG. 3: (a) front elevation and perspective view with face plate cut away diametrically to show complete barrier plate and with core portions omitted; (b) rear cutaway perspective and elevation with inner core portion fitted but partially cut away to expose internal features; (c) side perspective and cross section on the cut lines in (a) and (b); and (d) rear perspective and elevation with cut-away lines as in (c).

FIG. 9 illustrates in partially cut-away views a sector of the lock assembly with a lockout bolt mechanism in normal, non-actuated condition applied to the embodiment of FIG. 3: (a) rear end view; (b) rear perspective.

FIG. 10 illustrates in partially cut-away views the sector of the lock assembly of FIG. 9 with the lockout bolt mechanism in an interim, about-to-be-actuated condition: (a) rear perspective; and (b) rear end view.

FIG. 11 in partially cut-away views the sector of the lock assembly of FIG. 9 with the lockout bolt mechanism in locked, actuated condition: (a) rear perspective; and (b) rear end view.

FIG. 12 is a schematic diagram of an assembly process for the lock of FIG. 3.

### DETAILED DESCRIPTION OF EMBODIMENTS

The following description and accompanying drawings are illustrative and are not to be construed as limiting. Numerous specific details are described to provide a thorough understanding of the presently disclosed embodiments. However, in certain instances, well-known or conventional details, such as those discussed in the preceding discussion of the background, are not described in order to avoid obscuring the description.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Some embodiments may be described using the expression “coupled” and “connected” along with their derivatives. For example, some embodiments may be described using the term “coupled” to indicate that two or more elements are in direct physical contact. The term “coupled,” however, may also mean that two or more elements are not in direct contact with each other, but yet still co-operate or interact with each other. The embodiments are not limited in this context.

Broadly, the disclosure concerns a pin tumbler lock with adaptations to make it less vulnerable to attack. It is not being suggested that the lock having the adaptations cannot be successfully attacked. However, the adaptations are intended to make it more difficult for an attack to succeed and to require even greater effort and/or skill to be used by an attacker than may be required for an equivalent lock that does not have the adaptations.

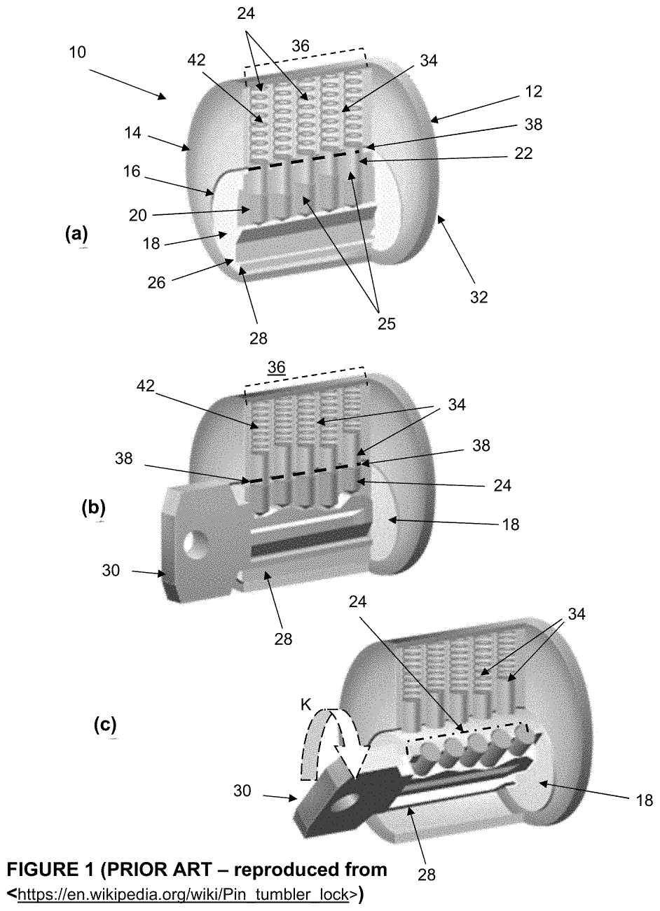

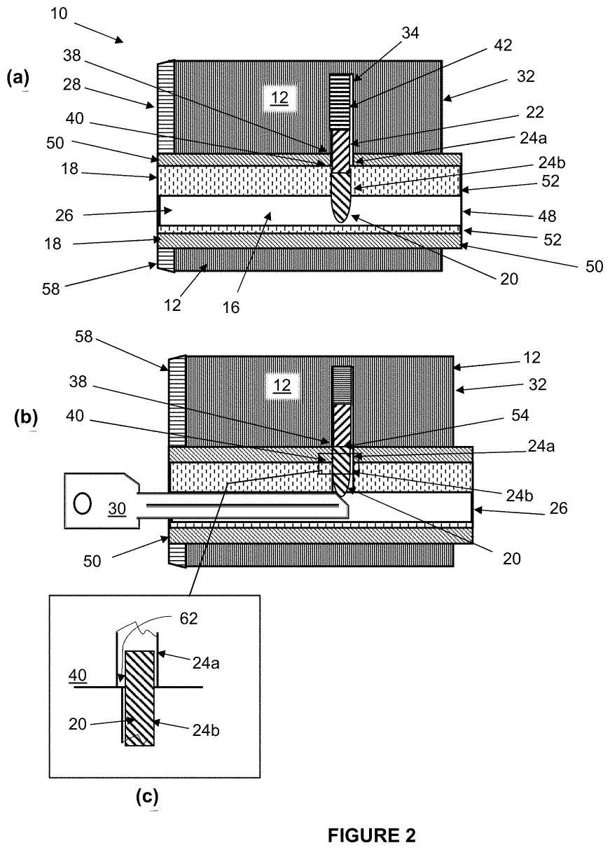

The pin tumbler locks in the embodiments discussed below have a core that is provided in two or more cooperating parts that are movable relative to each other and engageable and disengageable. The parts may be rotatable relative to each other but are configured to engage each other against relative rotation so that they will rotate in unison relative to the outer body of the lock when a correct key is inserted. One of the parts receives the key. A second part engages with the lock body so that it cannot rotate inside and in relation to the body without the key being in operative position in the first part. One of the parts is mechanically linked to the conventional cam that is moved at the opposite (rear) end of the body to front end when the core is rotated. These concepts will be elaborated on with reference to the accompanying illustrations, beginning with FIG. 2. Like parts encountered already in prior art FIG. 1 have like numbering.

FIG. 2 schematically shows a simplified version of a lock 10 of the disclosure in lengthwise cross-section, taken along the axis of the core-receiving bore 16 which extends within and through body 12 from front end 28 to distal end 32 at the back of the lock. The bore is occupied by a two-part core 18, which includes an outer core potion 50 having an axially extending passage 48 within. The passage is occupied by a second, inner core portion 52, which fits within said outer portion in a relatively snug, but not overly tight, fit that allows relative rotation without significant rotational force being necessary when the correct key is inserted. Passage 48 is axially parallel with body bore 16.

Formed within body 12 is a round-cylindrical pin-receiving shaft section 34, which aligns sequentially with pin shaft section 24a in outer core portion 50 and pin shaft section 24b in inner core portion 52. The tube need not be round, but may assume an alternative regular radial profile in an alternative embodiment.

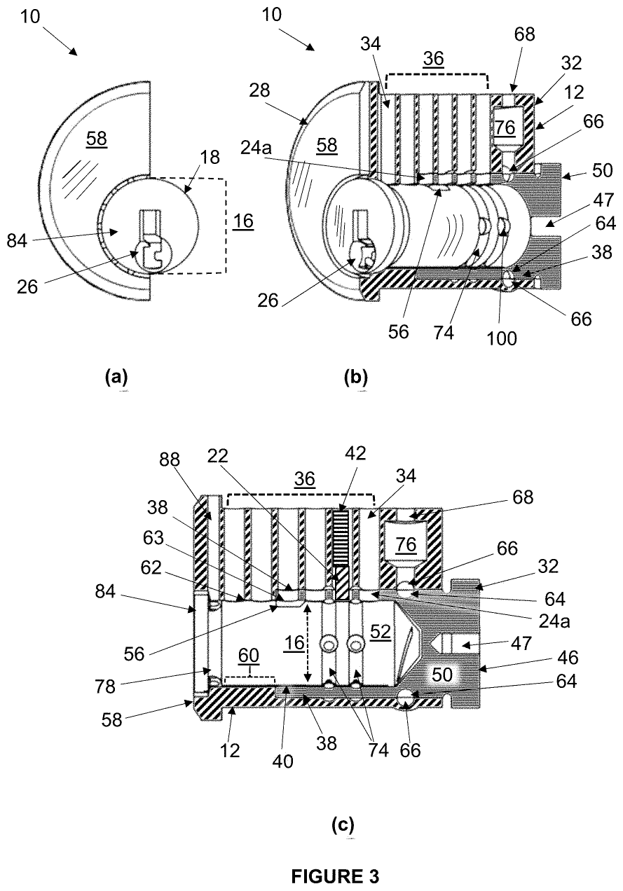

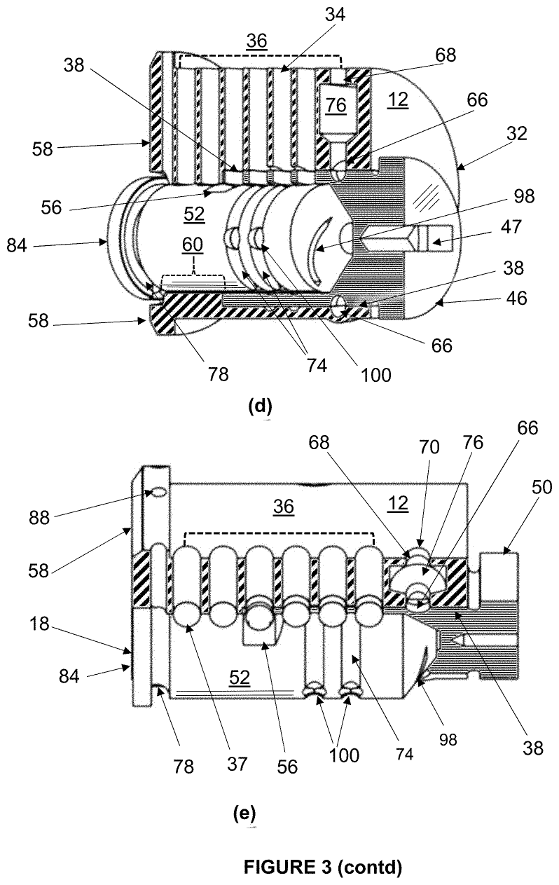

It will be noticed in FIG. 2(a) that keyway 26 is obstructed by a descended key pin 20, which rests on the bottom surface or floor 44 of the keyway (as orientated in FIG. 3). Stacked on top of the key pin in the aligned pin shaft sections 24a, 24b is a driver pin 22. Helping gravity maintain the key pin in obstructing position is a coiled spring 42 that lies wholly within the shaft section 34 that extends into body 12. With the pins stacked in this manner and with key 30 removed from keyway 26, the pins straddle the shear lines at the rotational interfaces between the core portions and the outer core and the body. Thus, driver pin 22 in this embodiment extends across shear line 40 between cores portions 50 and 52, as well as across shear line 38 between body 12 and outer core portion 50. In this configuration, and in the absence of overwhelming force sufficient to destroy the key and driver pins, inner core 52 cannot rotate relative to outer core 50 and outer core 50 cannot rotate relative to body 12.

In FIG. 2(b) a correct key 30 is illustrated sufficiently inserted into keyway 26 to push the stacked pins 20,22 upwards into the aligned shaft sections 24a, 24b, 34 against the bias of spring 42, so that the interface 54 between driver pin 22 and key pin 20 coincides or comes into register with shear line 38. With the pins in this configuration relative to the core and body, turning of the key will result in core 18 as a whole (that is including portions 50 and 52) being rotated relative to body 12 and de-actuating the locking function. Because key pin 20, when in this position, still straddles the second shear line 40, it performs a coupling function between the core portions, so that inner core 52 does not rotate relative to outer core 50. Instead, the two core portions rotate in unison. Outer core portion therefore actuates the external locking member that is coupled to the lock to open an external closure or other device, for example the ignition switch of a machine.

In the event of an attack on lock 10 in FIG. 2, such as by picking, the picking tool, which will be much narrower than the key to allow it to pass beyond any of the multiple pins in a pin tumbler lock, will cause key pin 20 to be elevated to a limited distance above keyway floor 44, until interface 54 reaches shear line 40. At this extent of displacement, driver pin 22 will have ascended above shear line 40 to be completely contained within the shaft section that lies radially outwardly of shear line 40. As this upper section, which includes sections 24a and 34, has a slightly wider diameter than section 24b, driver pin 22 will be eased up into the wider section. As it passes shear line 40, it will automatically strike the wall of the wider section and in most instances will come to rest momentarily on a lip 62 defined by commencement of the narrower shaft portion 24b.

As observed in the background discussion of prior art, a system that allows the attacker to note that the first shear line met as the pin stack is raised is merely an ‘apparent’ shear line, and that the second one met is the correct shear line, provides no defence against key impressioning attacks. This is because such attacks first raise all key pins to the maximum height, compressing the springs in the stacks, and then progressively lower the pins until they coincide or register with a shear line. Moreover, if an attacker has either read this patent specification or purchased a lock disclosed herein to practice on, the knowledge acquired would allow the attacker to endeavour to find both shear lines and then correctly set the key pin to the higher of the two found.

To address this challenge, the lock of this disclosure allows a manufacturer to choose to have a single driver pin/key pin combination, or a driver pin, middle and key pin. The lock manufacturer can ensure that the first shear line encountered when the key pin is raised occurs when the top of the middle pin aligns with the outer core/lock body shear line 38, and the second shear line is encountered when the top of the key pin aligns with the shear line 40 between the inner and outer core, and the middle pin straddles shear line 38 between the outer core and lock body. The top of the key pin refers to the end that is in abutment with the middle pin or driver pin in the pin stack.

The task presented to the attacker can be further complicated by using a spool driver pin or pins in a single pin stack. An attacker experienced with picking locks having spool pins will know that if they achieve a ‘deep false set’ they need to continue to raise the key pin against the ‘counter rotation’ until the spool crosses the shear line of the core.

However, if the pin stack in question involves both the inner and the outer core, this will all but guarantee that they will fail to pick the lock, as the spool will now straddle the shear line between the outer core portion and the lock body. When the pin stack includes only a single spool and key pin, the attacker must continue to raise the key pin until the spool passes the shear line between the lock body and core assembly, and hope that this or other pins do not drop back towards the keyway while other pins are being set. When the spool in question is a middle pin, the attacker needs to raise the spool sufficiently to allow the top of the spool to align with the lock body/outer core shear line 38, while ensuring the false set remains between the inner and outer core portions.

Should driver pin 22 not come to rest on lip 62, it will return under biasing force from spring 42 to its locking position, straddling shear line 40 and coupling inner core portion 52 to outer core portion 50. The lip is illustrated in the callout in FIG. 2(c). The striking of the pin on the lip will emit a soft clicking sound, which the lock picker will hear and interpret to mean that key pin 20 has been lifted to the conventional shear line 38 at the interface of core and body, when it had in fact been lifted only as far as the second shear line 40 between the inner and outer cores. In this configuration, inner core 52 becomes mechanically isolated from and rotatable relative to outer core 50. The lock picker will deduce from the apparent rotation of the core that their lock picking attack had succeeded. However, only the inner core would have been rotating: The second core portion in the form of the outer core portion will not be rotating, and will therefore not de-actuate the cam and the locking function of the overall lock. The cam will be mechanically isolated from the keyway holding inner core portion. The limitations inherent in the gauge of the picking tool will prevent it from forcing the pin stack further into the shaft so that interface 54 reaches shear line 38 between the outer core and the body. Using physical force on the core is likely to buckle or deform the pin stack, rather than cause the outer core to rotate relative to the body to allow the lock to be opened.

Referring to FIG. 3, and the embodiment there illustrated , the principles illustrated in FIG. 2 are applied to a pin tumbler lock 10 having multiple pin stacks in a body 12, which is of generally round cylindrical proportions. Each stack includes the portions 20 and 22 and operates in the way already described for the single pin.

Body 12 is penetrated by a bore 16, the diameter of which is pointed out generally by the broken line. The lock is shown front-on in (a) and in a perspective view in (b) with its outer casing removed. The core 18 is an assembly including outer 50 and inner 52 core portions, as shown in (b), (c) and (d), leaving bore 16 vacant in (a). The bore extends from the front, or keyhole end 28 of body 12, to its distal end 32, which is accessible from the back of the lock. Core assembly 18 is decoupled into its inner core portion 52 and outer core portion 50 before these are inserted into bore 16 from opposite ends. Outer core portion 50 is inserted from distal end 32 and inner core portion 52 from front end 28. As is common in the art, bore 16 is not coaxial with the body. However, this is not to be considered a necessary limitation. Once inserted, the core portions are coupled together as will be disclosed further with the intention that they rotate in unison when the lock is operated with the correct key, but they then decouple to rotate independently under attack conditions. The core portions may be coaxially aligned, for simplicity of construction and reduction of moving parts.

In this embodiment, body 12 includes a row 36 of six pin stack-receiving shafts of conventional design. The shafts extend radially outwards from the core-receiving bore 16, into body 12. In other embodiments, the shafts need not be arranged in a single row, but may extend at different angles from the core.

In this embodiment, as in the embodiment of FIG. 2, there are two shear lines, a first being the conventional shear line 38 between the body and the outer core, and a second running between the outer 50 and inner 52 core portions and marked with the numerical label 40. Should an attacker manage to pick the key pins (not shown) of inner core 52, raising them to meet the driver pins at the inner/outer core shear line, this will merely allow the inner core to rotate freely relative to the outer core while the latter remains held in place by the driver pins protruding down from the body 12 and biased by the conventional coiled springs to that the driver pins remain in position for straddling the conventional radially outer shear line 38 between outer core portion 50 and the body, as shown in FIG. 1. Should an attacker “bump” the lock to cause the key pins to be temporarily displaced to second shear line 40, the pins will still be straddling first shear line 38, resulting in the inner core, but not the outer core rotating, and the cam connected at slot 47 hence not being moved and the locking function remaining intact.

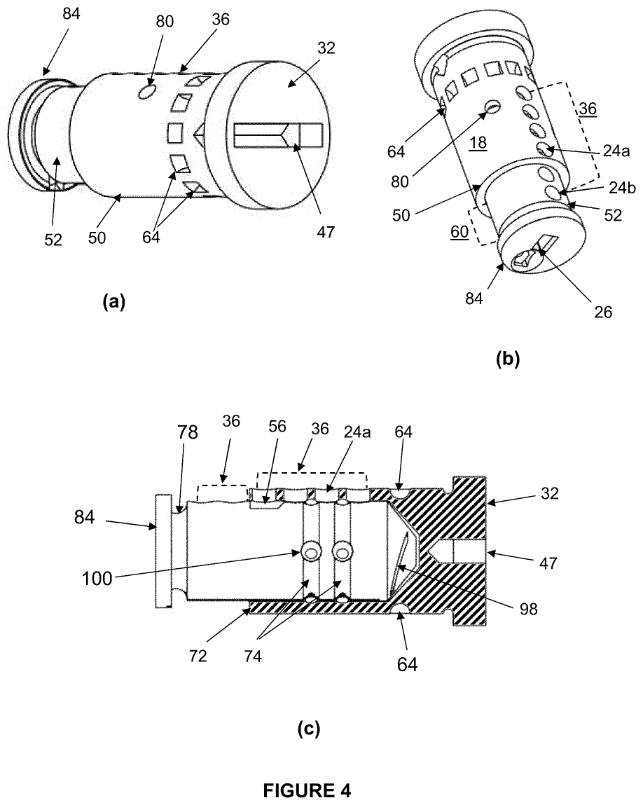

With reference to FIG. 4(a), each shaft 36 has a cap 37 (only one of which is labelled), providing closure at its outer circumferential end, which coincides with the outer surface of body 12, which in use is covered by outer casing 14 (as seen in FIG. 1), not shown.

As is known in the art, a cam assembly (not shown) is mechanically linked in operative use to receiving slot 47 at the projecting rear end 46 of outer core 50, to cause displacement of a locking bolt for the openable closure, for which the lock is used, when the outer core portion is caused to rotate.

As shown in FIGS. 3(c) and (d), outer core portion 50 does not extend fully from end to end of the body: It is spaced from the faceplate 58 that covers the keyhole end of body 12 by a gap 60, marked by means of a broken line. The gap assists in confounding an attack on the lock by drilling, because even if the attacker chooses to drill through the faceplate 58 and happens to bypass inner core 52 which is partially nested within outer core 50, the drill bit will not immediately or necessarily encounter and engage with outer core 50 in a way that can be used for applying sufficient rotational force to cause the pin stack (not shown) in the shafts to fracture at the outer interface 38. Instead, the pin stack is more likely to deform, causing jamming to prevent any relative rotation.

A correct key, when inserted into the keyway of inner portion 52 and turned, will cause both inner portion 52 and outer portion 50 to engage so that they rotate in unison. The correct key is able to achieve the engagement by causing each of the pin stacks to be displaced so that their interfaces 54 (see FIG. 2) between the key pins and driver pins all coincide or come into register at once with outer shear line 38.

As has been described, core rotation will likely occur when an object other than a key is forced into the lock and overwhelming rotational force is brought to bear on the core portions, so that the driver pins that straddle the interface or shear line 38 between outer core and body are caused to distort or fracture. However, as described, the lock in the present disclosure is adapted so that when overwhelming force is brought to bear, it will cause first disengagement of the inner and outer core portions at shear line 40, so that the driver pins remain intact and shear line 38 is not tested.

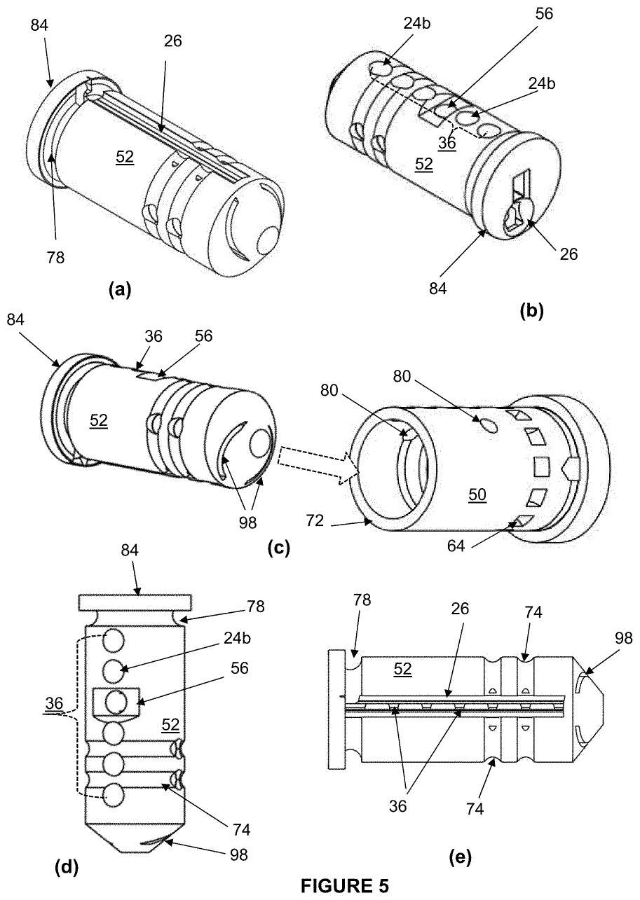

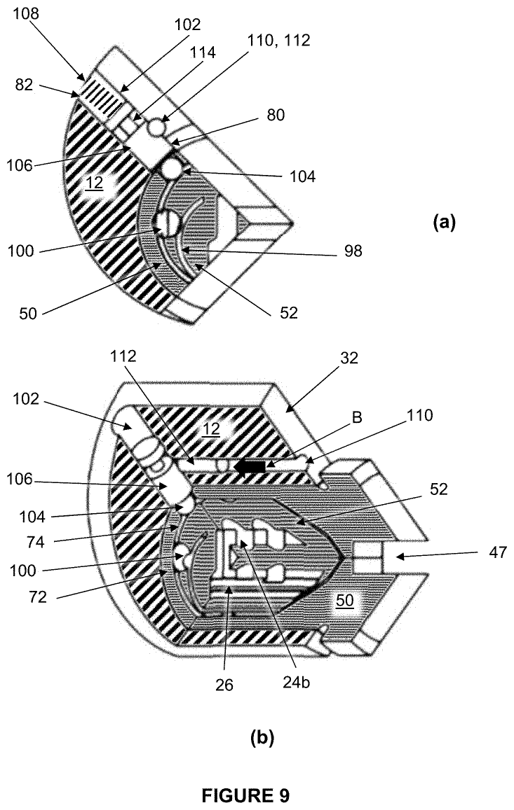

To protect the lock against removal of the core assembly by an attacker, features are provided to inhibit extraction of the inner core from the outer core and the outer core from the body. These are described with reference to FIG. 3 and further reference to FIGS. 4 to 8 when required. A further lockout method is described below with particular reference to FIG. 9.

A first extraction inhibiting feature to be discussed is a false shear line defined by a recess 56 formed in the outer surface of inner core portion 52, at the location of one of the pin stack shafts 36. This recess widens separation between the inner and outer core portions, providing an enlarged lip 63 and a false shear line against which a key pin in the shaft may be caught or be held up giving an attacker attempting to pick the lock that they had lifted the pin stack sufficiently to cause the key pin to be supported, whereas in fact the key pin has been moved to a position in which it still straddles the actual shear line 40.

Another feature for inhibiting extraction of the outer core portion from body 12 is a ball bearing mechanism in which ball bearings (not shown) are permitted to move along a circumferential bearing track or groove 66 (see FIGS. 3(b) and (c)) that is formed by cutting into the inner surface of bore 16 within body 12. Discrete cavities 64 are formed in a circumferential row in outer core portion 50, as best shown in FIG. 4(a) and (b). The cavities are sized to receive a portion of a ball bearing while the remainder protrudes. The cavities are located so that when the outer core portion is inserted into its operative location in bore 16, the row of cavities aligns with groove 66 in the bore surface.

For allowing ball bearings to be introduced into cavities 64, a conduit 68 is provided in outer body 12. Conduit 68 widens into an internal space 76 within body 12. Space 76 provides a reservoir for receiving the inserted bearings for temporary retention. An appropriate number of bearings, corresponding to the number of cavities, is introduced into conduit 68 and reservoir 76 and outer core 50 is rotated one full revolution relative to body 12. The rotation of the core allows one ball bearing from reservoir 76 to fall into each of the available slots 64 in the outer core. This causes engagement between outer core portion 50 and body 12 of the lock. The engagement so achieved prevents or at least inhibits axial movement of the core assembly relative to the lock body, while the bearings assist in allowing relative rotation of these assemblies.

Once introduction of the bearings is complete, a plug 70 (see FIG. 3(e)) is inserted in the entrance of conduit 68 to prevent the bearings from falling out of the body.

To remove the bearings, the lock assembly is orientated to align conduit 68 below each of the bearing cavities 64 in turn, so that the bearings are able to enter the conduit under gravity and be retained in reservoir space 76. Gradually rotating outer core 50 one full turn allows each bearing in turn to enter the conduit and pass through it and to space 76. When plug 70 is withdrawn from blocking the exit via conduit 68, the ball bearings may then pass through the space vacated by the plug, if required. Once all the hearings are out of the bearing track, the outer core is no longer engaged with the body and is liberated for withdrawal in an axial direction relative to the bore. The plug may be reinserted before or after the outer core has been removed.

This method of engagement delivers the benefit of core retention: Even if an attacker successfully pulls the inner core out of the lock, the outer core is held in place by the ball bearings, leaving the locking mechanism at the rear exterior of the body intact. The method results also in friction reduction and smother turning of the outer core relative to the body, due to the action of the bearings. It also facilitates alignment of the key pins to the correct depth in their shafts: Once the ball bearings are added, they advantageously help align the bearing track cavities 64 cut into the outer core with groove 66 in the lock body and simplify alignment of the pin stacks between them.

It will be appreciated by the person skilled in the art of lock security that this method of core retention is suitable also for use in traditional single core pin tumbler locks. These would obtain the benefit of friction reduction and pin stack alignment, and possibly enjoy a reduction in the effectiveness of core pulling attacks.

It will be appreciated too that the bearing track configuration may be altered within the scope of this disclosure. For example, the recesses may be of differing lengths. By way of a further non-limiting example, the track on the outer core may be formed as a continuous circumferential groove, as opposed to a line of discrete cavities.

Furthermore, there may be more than just one bearing track-and-groove pairing provided. The additional track or tracks may be located adjacent the first, or may be spaced distally from it. For example, a second track may be located adjacent the front end of the outer core, even being placed intermediate two of the pin stack shafts. In another embodiment, the outer core may be extended to reach the front end of the body and may have a bearing track that aligns with a groove correspondingly located in the bore of the body, perhaps just to the rear of the faceplate 58.

To retain the inner core in its operative position within the outer core, an engagement arrangement analogous to the above is used. Ball bearings having a diameter that is larger than the thickness of the wall 72 of outer core 50 are selected. One or more ball-bearing tracks are fashioned so that they lie between the outer and inner cores for the ball bearings to follow and move within. Thus, into the outer surface of inner core portion 52 there is cut a pair of circumferential grooves 74 to provide bearing tracks. These grooves are located to align with formations in the inner surface of outer core wall 72 and to define tracks along which ball bearings are able to be displaced when inner core 52 is rotated within outer core 50.

In locations in outer core wall 72 lying above each of tracks 74 when the inner core portion is operatively located within the outer core portion, one or more holes 80 are drilled to a diameter just wide enough for each to receive one of the ball bearings and to allow it to pass through wall 72 to seat partially within track 74 with a significant portion of the bearing remaining located within hole 80 in wall 72. The holes may advantageously be equally spaced about the circumference of the outer core portion.

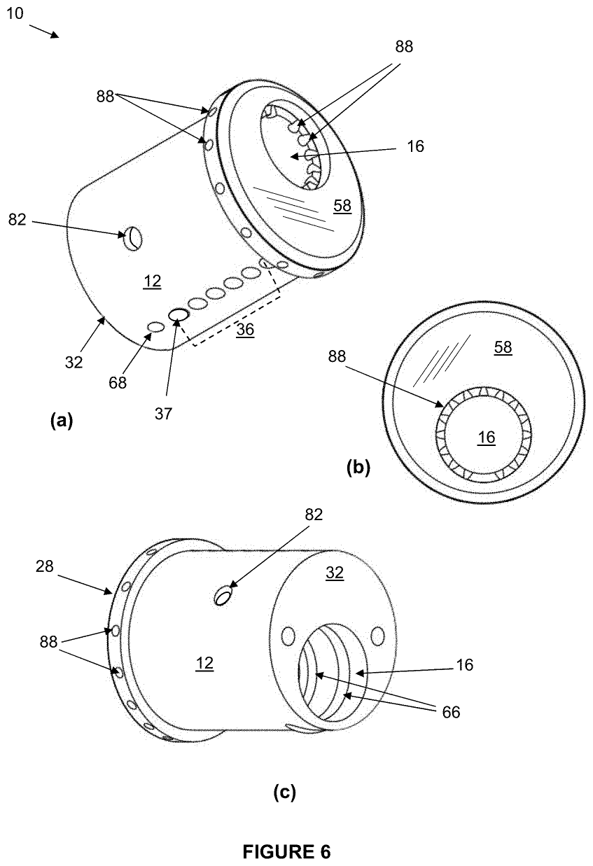

Referring to FIG. 6, access holes 82 are drilled through lock body 12 at locations lying directly over each of the tracks 74 in the inner core when the inner core is in operative inserted location. One access hole per track is sufficient. The access holes provide communication from the exterior of the lock body to the inner core ball bearing-receiving tracks 74 via outer core portion wall 72. By causing the body to rotate relative to the outer core, ball bearings are introduced through outer access holes 82 to locate individually and sequentially in each of the plurality of inner access holes 80 in the outer core and seat into tracks 74 in the inner core. When outer access hole 82 containing a ball bearing comes to locate in alignment with a hole 80 in the outer core, the ball bearing will drop to be discharged into the hole to seat into the inner core track, its operative location. When the body is rotated so that outer access hole 82 goes out of alignment with inner access hole 80 from which the ball was discharged, the seated ball will remain in its operative location. Rotating the body further relative to the core assembly will bring hole 82 in the body with the next hole 80 in the outer core and a second ball bearing will be discharged to drop into operative position in the inner core track while being partially retained in hole 80. The process may be repeated until all available holes in the outer core receive a ball bearing or, in the case where there are fewer ball bearings than receiving holes 80, until as many ball bearings as have been provided have been discharged.

Thus, if three holes are drilled into the outer core to locate over each of two tracks formed in the inner core, there should correspondingly be 6 ball bearings inserted, three for each track and angularly spaced at 120°. The numbers of channels, ball bearings and their angular spacings are given as non-limiting examples, and are subject to variation without affecting the scope of the disclosure.

When lock body 12 has rotated a full revolution relative to core assembly 18, all the available outer core holes should ideally have been filled by respective ball bearings. To prevent escape of the ball bearings, should later relative rotation of core and body result in alignment between the access holes 80, 82, a plug is inserted in outer access hole 82 for each track 74.

The ball bearings selected for this embodiment are of greater diameter than the thickness of outer core wall 72 and therefore at all operative times protrude only partially from the wall into the tracks 74. The tracks are of a depth less than the diameter of the ball bearings. Each of the ball bearings therefore rolls along the track within the confinement of the hole to which it has been assigned within the outer core wall. This structure allows relative rotation between inner and outer core, but at the very least will inhibit their relative movement in an axial direction.

If an attacker were to apply force to pull or push the inner core axially in the lock, the ball bearings would not follow the inner core. Under sufficient force, the ball bearings are expected to be pushed radially outwards from tracks 74, and to ride up towards the edge of the bearing track and be pushed into the wall of the lock body, jamming the core and body components against further cooperation.

The only way for the inner core to continue moving out of the lock is for deformation to occur within and between the components. The inner core is therefore sacrificed to keep the outer core, which mechanically links to the cam and lock-operative mechanism external to the lock body, intact.

When the inner core is made from a slightly softer or more malleable metal than the bearings, the bearings when subjected to sufficient attacking force, will first be forced tightly up against the lock body. Sufficient further force is expected, by design, to cause the ball bearings to plough grooves into the inner core in a generally axial direction. Thereafter, excess metal from the inner core will build up ahead of the ball bearing, requiring more and more force to continue to separate the core assembly from the body. Usually, the attacker attempts to extract the core assembly from the body by pulling the core towards themself. However, should the attacker elect to attempt to push the core assembly away and through the lock body, the ball bearings between the outer core and the body will similarly deform the interface between these components again leading to complete jamming.

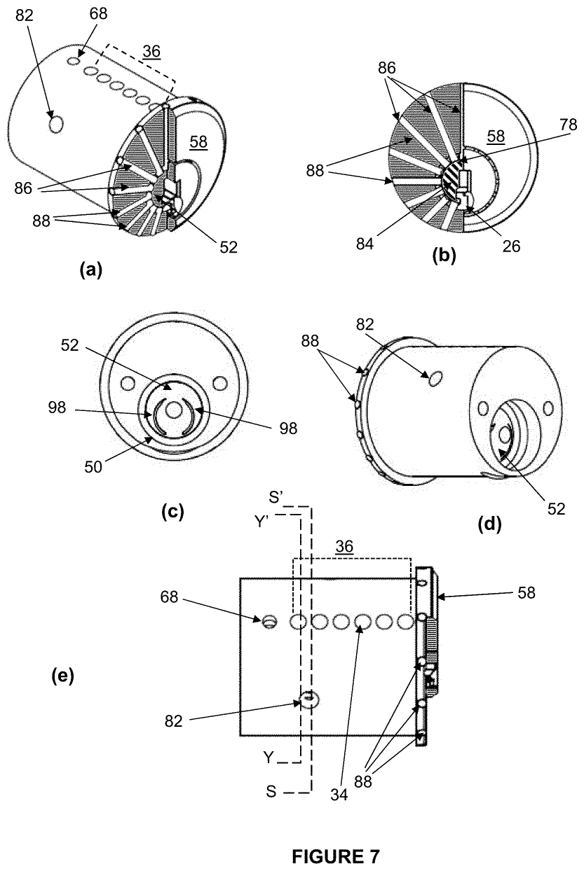

A further or alternative way of enhancing lock protection will now be described with particular reference to FIG. 7. However, FIGS. 3, 4 and 6 also bear reference. In this embodiment, the method and structural features illustrated are not restricted to use with a core assembly having inner and outer portions as already described, but may be applied to a lock having a conventional unitary core. Like parts in previous figures will continue to have like numerical labels.

It will be appreciated that role of the inner core portion 52, facing a would-be attacker, is sacrificial in nature. Since the inner core itself does not extend the full length of body 12 and has a blind keyway, it cannot be retained in position within the lock body in conventional manner, such as by means of screws or a c-clip at the rear end 32 of the lock. To address retention under frontal attack, a deep groove 78 is cut into inner core portion 52 between the frontal anti-shim ring 84 and the closest pin stack shaft in row 36.

This inner core portion is inserted partially into outer core portion 50 and the assembly thus formed it then inserted into lock body 12. The inner core portion is inserted only partially, but to the full extent possible, because the cavity into which it is inserted in the outer core portion is sized so as to ensure that the entire inner core portion cannot be fitted inside it and at least a portion of the inner core portion will protrude. This arrangement defines the gap 60 referred to above, located between outer core 50 portion and face plate 58 of the body.

As shown in FIG. 7, a series of drill protection rods 86 are inserted into shafts 88 drilled in an inward radial pattern, centring on internal core portion 52. The entrances of the shafts are shown in FIG. 6. The rods 86 are pushed on radially until they protrude into frontal groove 78, cut into the inner core portion behind the anti-shim face of ring 84. The rods are manufactured from a substantially relatively harder substance than the surrounding or adjoining components. For example, the rods may be made from a hard metal carbide, such as tungsten carbide, titanium carbide, tantalum carbide and the like, in comparison with plate 28, which may be of brass or stainless steel.

In known locks, such rods would be inserted no further than a fraction further than the conventional shear line 38, located between outer core portion 50 and body 12. By inserting the drill protection rods to reach into groove 78, they provide a barrier to penetration of second shear line 40, located between the inner and outer core portions of this disclosure.

Retaining the core has the result that if a core puller is used to extract this core, the attacker would typically place a pressure plate on the face of the lock and push it hard against the front plate of the lock that shields the drill protection rods, while at the same time endeavouring to pull the core past or through the rods. However, the pressure plate is itself holding the front plate and rods in place. In effect, the attacker is exerting force against themself. A significant increase in the force is required to extract the core, but this is liable to cause significant deformation of the inner core portion during the extraction process, jamming it fast against extraction instead.

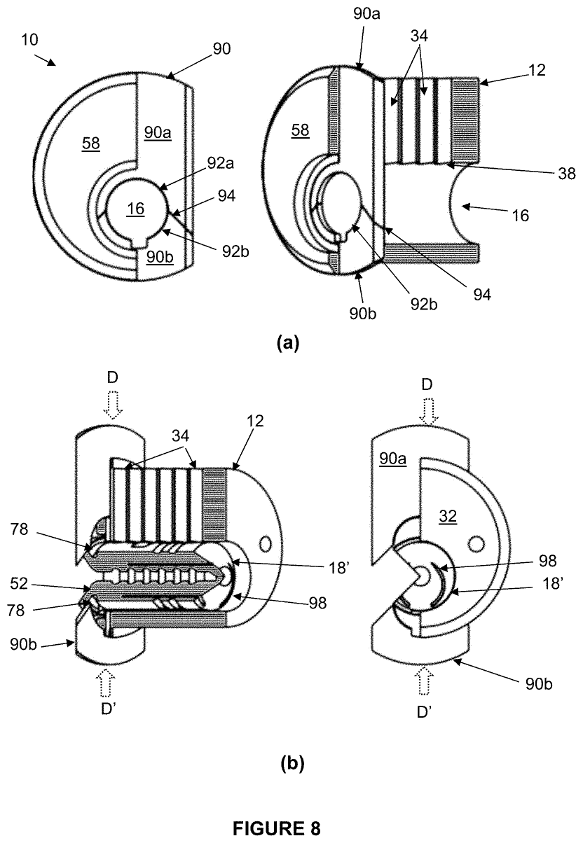

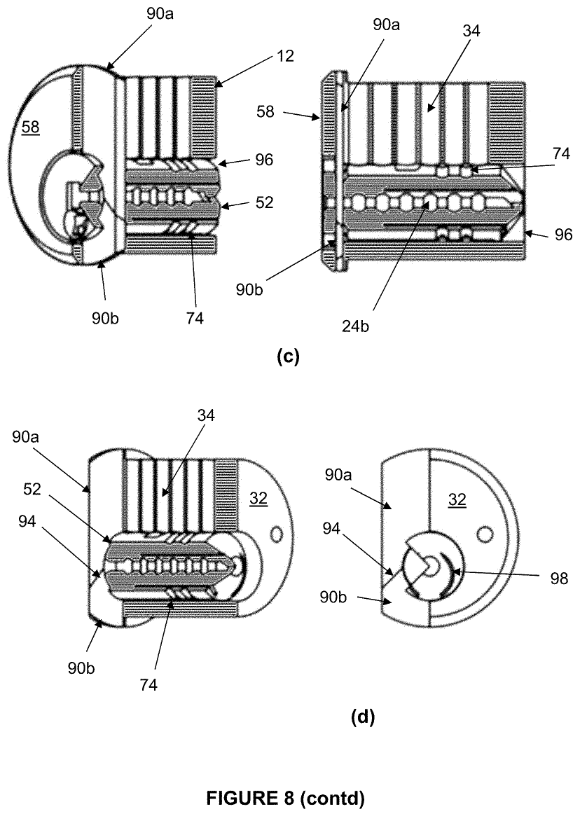

As an alternative to (or even in addition to) the rods, a drill protection plate 90, shown in front and front oblique cutaway views in FIG. 8(a) without the core assembly 18 in previous figures fitted, is formed in two sections 90a, 90b. Each section has an arcuate cut-out 92a, 92b for slotting into circumferential circular groove 78, as illustrated in FIG. 8. The two sections meet at line 94 when operatively fitted into the groove. Apart from the circular opening formed where the two cut-outs meet for admitting the inner core portion, the complete plate provides a continuous, relatively hard barrier to accessing outer shear line 38. When the assembled lock is fitted to its intended closure, it is conventionally seated within a front outer collar, or rose. The rose serves to hold the two sections together in place once lock is fitted in its operative location.

FIG. 8(b) illustrates the use of the plate sections without an outer core. Instead, the core is included of a single section 18′, which is shaped to resemble inner core 52 from previous illustrations and embodiments. However, the single core section may assume a different shape or form in other embodiments.

The presence of the barrier requires a notch be cut into the correct key to allow it to pass the barrier when caused to rotate in the normal unlocking action. Advantageously, the barrier, can frustrate lock picking or decoding tools that rely on bottom of the keyway tensioning. This arises because turning of the inner core to either tension the lock or unlock the lock will cause the tool to collide with the barrier and will absorb the attacker's rotational force into overcoming the barrier as opposed to turning the core.

The plate and rods provide at least some degree of protection for outer core 50 against attempts to separate it from lock body 12. Of course, total and complete protection cannot be guaranteed against an attacker intent on exerting whatever force he finds necessary to destroy the lock. A reverse view of the plate arrangement is presented in FIG. 8(b), showing core assembly 18 fitted into body 12 and the directional arrows D, D′ showing plate sections 90a, 90b being pushed into position with their arcuate cut-outs directed towards groove 78 for operative seating.

FIGS. 8(c) and (d) show in cutaway representations the embodiments of (a) and (b) in oblique and end views from front and rear. Inner core 52 has been inserted but without outer core 50 present, for illustrative purposes, leaving a gap 96 between inner core 50 and the inside of body 12. Drill protection plate sections 90a and 90b are shown brought together in operative mode.

Where rods as well as plates are used, an additional groove parallel to groove 78 is provided in inner core section 52 or core 18′. This particular embodiment is not shown.

An optional measure to thwart attack on the lock is found in removing some of the core material to create a cavity in the inner core portion. In the embodiments of FIGS. 3 to 8 there are twin such cavities in the form of arcuate thin slot-like crevices 98. These ensure that under forceful attack the inner core portion will fail in a controlled manner by permitting relative displacement of the innermost portion of the inner core portion adjacent to or between the crevices. The exact dimensions of these inner crevices are determined by simply subjecting the lock to attacks of increasing force and testing the cavity dimensions until desired failure is reliably achieved.

In the case in which an attacker forces a screw into the keyway and lodges it securely in place for pulling, the crevices will deform when the attacker exerts pulling force on the screw (for example by using pliers or a pressure plate and lever). By way of example, the arcuate crevice provides structural weakness that allows the most centrally located part of the core portion to be rotated independently of the remainder of the inner core portion, and even to be pulled towards the faceplate 58. The aperture formed by the drill plate sections 90a, 90b has a smaller diameter than the full inner core portion and this resists against the central part being pulled out. This configuration aids in allowing controlled failure of the inner core under excessive force, without the outer core being compromised. The innermost portion will resultantly shear away from the remainder of the inner core portion and will rotate freely and independently. Through this arrangement, it is intended that an attacker should be deceived into thinking they had managed to rotate the core, but then to question the reason why the lock did not open. Meanwhile, the outer core portion the operates the locking mechanism externally is left intact. To disrupt this, additional violence will need to be perpetrated on the remaining parts of the lock or closure, increasing the risk of discovery to the attacker resulting from noise made and additional time required.

In a further embodiment, both the inner and outer core portions are made long enough not to leave a gap 60 between the outer core portion and the faceplate assembly. That is, outer core portion 50 extends right up into abutment with the inside of faceplate 58. In this embodiment, inner core portion 52 will be substantially completely nested within outer core portion 50.

In further embodiments, the use of multiple rows or arrangements of pin stacks instead of just in a single row 36 may be implemented. Other refinements include known measures such as security pins and side bars adapted to be included in embodiments of this disclosure.

A further refinement is a lockout pin device described with particular reference to FIG. 9, in which (a) is a partially cut-away cross section taken along line Y-Y′ in FIG. 7(e) and (b) is a slice extending forward to line S-S′. This refinement serves to isolate the outer core portion from the inner core portion in the event of an attack on the lock and activates a lockout function which uses a lockout pin device operating through the outer core. When the lock is in normal operative locking condition, the pin stacks will be fully descended in their respective shafts 34 (FIGS. 2 to 8), with the key pins protruding into keyway 26 and straddling shear lines 38 and 40. The stacked key pins and driver pins are under biasing force from springs 42.

When an attempt is made to pick the lock by displacing each pin stack individually in the attacker's chosen sequence, each of the key pins is displaced as far as shear line 40 between the inner and outer core portions, at which stage the attacker should hear or feel a slight click that suggests the key pin has become hung up at conventional shear line 38 between core assembly 18 and lock body 12. In this actual condition, inner core portion 52 is able to be rotated independently of outer core portion 52. This result may mislead the attacker further into believing they had picked the lock successfully because of the core assembly appearing to rotate and therefore presumably move the locking cam connected at slot 47 into open position. It will be recalled that when the lock is being correctly used—that is with the correct key—the inner and outer core portions move in unison because the key has raised the key pin/driver pin interface to shear line 38 with the key pins straddling inner shear line 40. Therefore, in the present disclosure, independent rotation of the inner core relative to the outer core is a signal of an abnormal condition in the lock, suggesting probable attack. To further frustrate such attack, a lockout function is provided for triggering in circumstances of independent inner core rotation.

To enable the lockout function to be triggered, use is made of an additional access hole in body 12 sized no larger than is necessary to receive a ball bearing of selected diameter to roll within tracks 74 in the surface of inner core 52. The access hole is of the kind labelled 82 in FIG. 6 and FIG. 7 and aligns with one of the apertures 80 in outer core portion 50 to define a temporary shaft 102. Apertures 80 are located radially above ball bearing tracks 74 of inner core portion 52. One or more dimple-like depressions 100, large enough for fully receiving a ball bearing 104, are sunk along bearing tracks 74.

The ball bearing, seated under normal (not attack) conditions in hole 80 in the wall 72 of outer core portion 50 and therefore at the inner end of shaft 102, is not normally located in a depression. It is primarily intended to inhibit axial extraction of inner core portion 52 from outer core portion 50 and when inserted, as described above with reference to FIG. 7 does not occupy a depression 100. However, when inner core 52 is turned relative to outer core portion 50, ball bearing 104 is displaced to move relative to inner portion 52 along track 74. As inner portion 52 is turned, outer core portion 50 rolls the ball bearing along track 74 until the ball bearing reaches and is received into one of the depressions 100, vacating the track path. To ensure the ball bearing enters the depression, a driver pin 106 is placed above ball bearing 104 in shaft 102 when holes 82 and 80 are in initial alignment and a biasing coiled spring 108 is placed above the pin before aperture 82 is capped to close the shaft, compressing the spring at least partially. The cap is not shown. Spring 108 exerts sufficient force through driver pin 106 on to ball bearing 104 to hold it against the surface of track 74, without preventing it from being rolled towards depression 100 in an attack situation.

In normal condition where relative rotation of the core portions is not taking place, the inner core continues to support the ball bearing in the track. However, should the inner core be caused to rotate relative to the outer core for any reason, the ball bearing will be displaced along the track until it reaches the depression. Under the bias of the spring, it is urged to enter the waiting depression and will remain there trapped, should the inner core continue to be rotated.

The sequence of internal conditions in the lock core assembly is illustrated in the partially cutaway diagrams of a sector of the lock and core components in FIGS. 9 to 11. FIG. 9(a) shows an end section view and FIG. 9(b) a rear oblique view of a cutaway sector of the lock body 12 and core assembly 18, in which body 12 contains outer core portion 50 and inner portion 52 in a normal operative condition. The embodiment in this illustration differs from others described previously in that it shows the temporary radially directed bore 102 containing driver pin 106 and spring 108 exerting force on ball bearing 104 that lies on track 74. It can be seen that ball bearing 104 is substantially spaced from depression 100.

Intersecting substantially orthogonally with driver pin shaft 102 is an axially oriented shaft 110 which contains a lockout bolt 112. The degree of intersection is partial in this embodiment, in that a little less than about half of the shaft diameter encroaches on bore passage 102. Shaft 110 contains an axially displaceable bolt 112 for fitting into a mid-section 114 of lockout pin 106. Mid-section 104 has a substantially smaller diameter than the remainder of pin 106, leaving a space into which bolt 112 can be inserted and received should the mid-section reach the location of intersection.

Bolt 112 is also biased by a spring (not shown) inserted behind it into shaft 110. The spring exerts biasing force in the direction of directional arrow B. Should it happen that spring 108, acting via pin 106, urges ball bearing 104 into a depression 100, pin 106 will descend to protrude into track 74 in the inner core portion. This will result in mid-section 114 of pin 106 becoming positioned at the intersection of bores 102 and 110. The spring (not shown) acting on bolt 112 will push it into the space alongside the mid-section 114, barring pin 106 from being pushed out of track 74 unless bolt 112 is withdrawn from its barring condition.

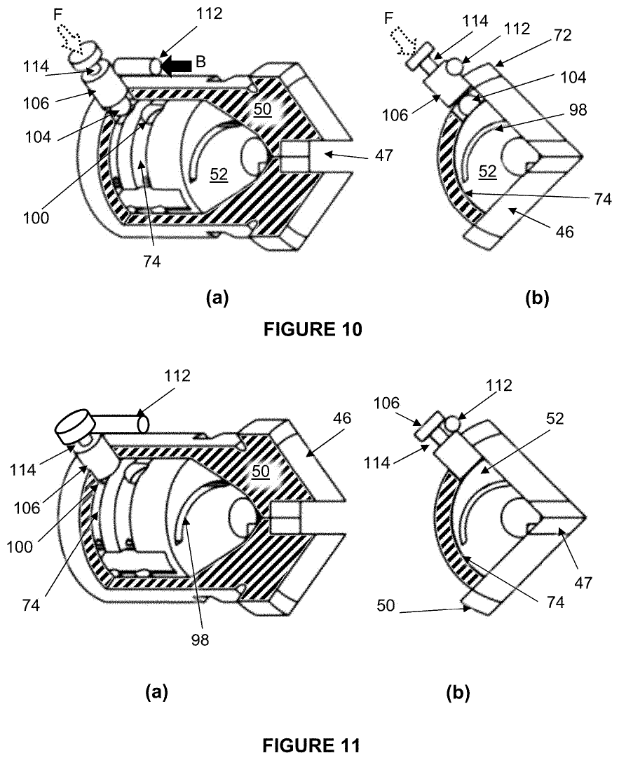

In FIGS. 10 and 11, the lock body has been omitted for ease of interpretation. Otherwise, the views given correspond to those of FIG. 9 and like parts carry like numbering.

FIG. 10 illustrates an interim condition in which the ball bearing is poised above and ready to enter depression 100 with force being exerted on bolt 112 in the direction of arrow B. Radially inward force is being exerted on pin 106 by spring 108 in the direction of arrow F. With space in depression 100 radially inward of ball bearing 104 and available to be filled by it, the biasing force F urges the ball bearing out of the track 74 and into the depression before inner core portion 52 can be turned further. The depressions marked 100 can be elongated if desired to provide greater protection from core spinners.

FIG. 11 shows the ball bearing in its received position within depression 100, having been forced into it by spring 108 directing force in direction G. Lockout bolt 112 now lies against the thinner mid-section 114 of driver pin 106, barring withdrawal of this driver pin from its shaft 102. In this condition, inner core portion 52 can still be rotated relative to outer core portion 50, so that the locking mechanism is not actuated to unlock the closure attached to the cam connected at port 47. The attacker will not realise the reason unless they are aware of the internal structure and configuration of the lock. However, they will not be able to reach the lockout pin as it is on the closure side 32 of lock body 12. The bolt prevents the pin being pushed back up the lockout shaft. Deforming the bolt will wedge.

The lockout pin of this disclosure differs from a conventional trap pin of the kind disclosed in U.S. Pat. No. 3,349,588, because it does not inform the attacker that the attack has been detected, nor is it directly susceptible to lock shearing once activated, as the lockout pin does not trap the inner core, nor require the trap pins in cross section to contain less metal than a standard pin. To enhance the resistance, the lockout pins may intentionally be made of a stronger metal than the standard pins.

Of note in the previous section a brief discussion of spool pins and “deep false set” was mentioned. More precisely a “deep false set” is an example of the inner core moving independently of the outer core. Hole 100 has been depicted at some distance from the lockout pins. The lock designer in choosing to use spool security pins can also if they desire place the hole such that the ball bearing is either some distance from this hole or rests on the lip of this cavity, and in the latter case, the movement achieved via a “deep false set” being sufficient to allow the bearing to enter the cavity and the lockout pins engaging.

Given the above, if the attacker has knowledge of this patent, in achieving a “deep false set” the attacker must decide if they believe the owner of the lock purchase the former or latter of the above decision. If the former, the cavities are at some distance from the lockout pins and the attacker can continue in their picking attempt safe in the knowledge that the lockout pins have not engaged, and if the latter the lockout pins and bolts have already engaged and further attempts to pick or sheer the lock are now futile. With the important point being that knowledge of this patent does not tell the attacker which of these two situations they are now in.

In the accompanying figures, the outer core portion is shown covering pin stacks 3, 4, 5 and 6. If this embodiment, if a spool driver pin is placed in pin stack 2, an attacker should, on discovering that this is a false pin set, push this spool above the inner core portion shear line 40 so as not to impede rotation of the core assembly relative to the body 12. However, if the outer core portion extends sufficiently to cover pin stack 2 and the lock designer has placed a short spool and driver pin above the key pin, the attacker should not raise the pin but leave it in the false set. Furthermore, if the outer core portion extends to cover pin stack 2 and the designer has included a single long driver spool pin in the stack, the attacker needs to not only raise the spool past the shear line 40 between the inner and outer core, but to shear line 38 between the outer core and lock body.

Another frustrating measure that the lock designer may implement is to hollow out the underside of the spool and cut into the surface of either the inner or outer core portion the depressions described in the Hines key system. When an attacker encounters a spool pin, they may or may not already be locked out from opening the lock. If not locked out, they must respond in one of three ways according to the spool configuration encountered, in the knowledge that an incorrect choice may result in their silently being locked out from picking the lock open, and/or being explicitly locked out by the lock seizing. Even with full knowledge and understanding of this they will not know which of the three options would be the correct choice for them to make for the specific lock in front of them.

Finally, unlike in the case of prior art locks, once the lockout pins have engaged, shearing of the lock neither opens the lock, nor hides the fact that the lock has been subjected to a significant attempt to open it—even if the shearing action has resulted in the inner core portion being rotatable relative to the outer core portion.

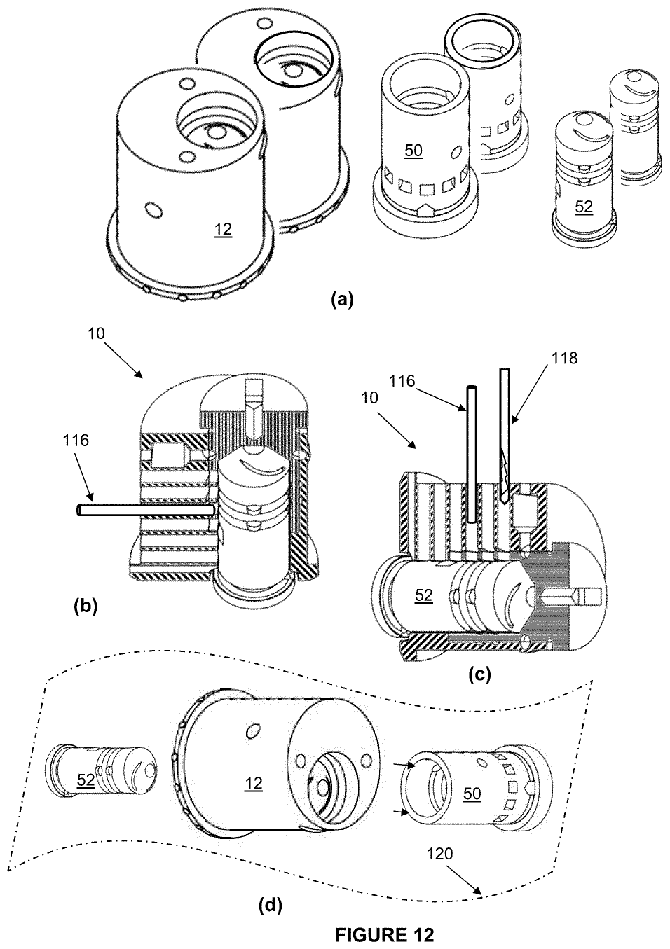

An advantageous method of manufacturing the dual-portion core and lock body will now be described with reference to FIG. 12. This method helps reduce tolerances that facilitate lock picking by creating a bind order.

In the case of a pin tumbler lock manufactured according to traditional methods, the ‘correct’ key when presented in the keyway functions to ‘correctly’ bring into alignment one or more pins or wafers within the different pin stacks so that the gap between the key pin and driver pin in each stack aligns with the shear line between the core assembly and the body, or between portions within the core assembly. When such alignment is achieved, the core assembly or core portion at which the shear line is defined is not prevented from being turned past a certain point relative to the body or other core portion with which it is configured to cooperate.

As previously discussed, the core assembly generally fits within the lock body, so that each contains at least a part of one or more of the pin stacks. In a perfect manufacturing world, each hole bored into the core to provide part of the complete pin stack shaft 24 would be perfectly located, as would each corresponding pin shaft portion 34 bored into lock body 12. This may be referred to as the “perfect placement model”. However, in the real manufacturing world, these shaft portions are bored ‘within tolerance’: This means there is allowed to be a positional error as long as the positional error does not exceed some pre-determined tolerance. It is generally assumed that the smaller the ‘tolerance’ is, the more care needs to be taken in creating the lock, leading to higher manufacturing costs.

Implementing a “perfect placement model”would by extension also achieve “perfect alignment” of the shaft portions in the assembled product, as each shaft portion in the respective components would line up perfectly for each pin stack at the predetermined location.

Given that even high-end locks can be defeated via a skilled picker exploiting ‘the bind order’ these minute tolerance errors cause in pin stack misalignment, these minor shaft discrepancies represent real world failure in lock manufacturing, as they allow picking and potential decoding of the lock. Therefore, instead of striving for the “perfect placement model” where the focus is on reducing the tolerances to some lower more ‘acceptable’ value, the present inventor restates the challenge as that of striving for a “perfect alignment model” in which tolerances are eliminated as shaft location criteria. This is not to condone accepting a worse tolerance in pin stacks for the sake of cutting manufacturing costs, but to allow apparent tolerances to be higher than would otherwise be achievable, all other things being equal. The improvements in apparent tolerances within alignment may warrant selecting key pins, drivers and security pins of higher tolerances to extract further advantage from this achievement.

In pursing the goal of perfect alignment, each of the major lock components being body 12 and core assembly 18, is manufactured separately as before, except that each of the pin stack shaft portions that is independently drilled ‘within tolerance’ within each component, is bored to a narrower diameter than is required in the final lock to serve as a pilot shaft for later final drilling. Generally, the diameter is suitably narrower if it is less than about twice the tolerance allowed for the specified shaft diameter.

The manufacturer then selects one of each major component, namely the inner and outer core portions and the lock body 12 already described, so that they can be assembled temporarily into a coherent single unit for treatment. To achieve such temporary condition, the manufacturer coats each selected component in a low temperature fluid solder, for example Wood's metal or Rose's metal or a dissoluble adhesive, brings the coated components together into a loose assembly and aligns the undersized pin stacks, using one or more guide rods if necessary.

Thereafter, the assembly is left as the case requires to allow the adhesive to set or to cool to the point that the solder ‘sweat welds’ the components into a single body of metal. When the components have suitably adhered, the body is returned to a drilling or boring machine to bore and ream, and, if necessary, polish pin stack shafts to specified depths. The machine may be same one used for boring the original shaft portions, or a different boring rig on the production line.

One may assume that the boring machine used is not perfect and that it can bore each hole only to ‘within tolerance’ positional accuracy, and that each pin stack shaft bored by this machine may have its own independent positional error. However, independent of positional error, while the machine is boring past a given shear line in say pin stack 1, any positional error present in the outer component at the shear line with the inner component is faithfully replicated at the inner component.

Moreover, as the components have been associated by being formed temporarily into a single body of metal with no relative movement possible between them, there will continue to be no relative movement between them in the time it takes between boring a given pin stack and the next.

The same reasoning applies for each final pin stack shaft that is bored. Consequently, while the machine is boring past a given shear line in any given pin stack shaft, whatever positional error is present in the outer component at the shear line is faithfully replicated at the inner component of the same shear line for the pin stack shaft in question. To sum up, as long as one of the pin stack shafts is in alignment, the others will also be in alignment in the associated components, according to the present method.

In preparation for final lock assembly, the associated components that have temporarily been fixed together are first separated. This is achieved for the adhesive case by dissolving the adhesive in a suitable bath or injecting the solvent into the adhesive body. For the sweat welded case, the assembly is heated to sufficient temperature to melt the solder, for example by placing the body into a bath of water heated to a temperature in the range from 60° C. to 80° C. Alternatively, steam may be injected into the body to free the components. Thereafter, the set of freed associated components for making the one lock are kept together, cleaned and reassembled, with additional components necessary for the final product being added.

It will be appreciated that by implementing the above “perfect placement” model, a boring machine may produce a lock having random positional error, yet the pin stack shaft alignment will be of far greater accuracy than would otherwise result.

The “perfect placement” process is schematically depicted in FIG. 12. In (a), core components 50,52 and lock body 12 are be manufactured separately, each with its own tolerance imperfections leading to inevitable misalignments between the bore sections 34, 24a and 24b that receive the pin stacks. These sections were shown in FIGS. 2 and 3 previously.

The pin stack shafts are deliberately undersized by twice the accepted tolerance of the specified diameter, so that they at least mark the locations specified for the shafts in the finished product, functioning as pilot holes for the final drilling step. These three components are then assembled to form a blank lock body 10 in FIG. 12(b). The pin stack bore sections 34 are then aligned to the extent feasible and at least one guide pin 116 is introduced by insertion to maintain the alignment. The components are then sweat welded with Rose's metal to cause them to adhere together to form temporarily a single body. The guide pin is then removed and the pin stack shafts are redrilled 118 into the assembled workpiece 10 to final size and depth with one drilling machine as in FIG. 12(c). The boring process is assumed to have independent random positional error (within tolerance) for each pin stack. This causes the bore sections in outer body 12, outer core portion 50 and inner core portion 52 to be more accurately aligned than in traditional methods, because as long as the sections of one of the pin stack bores line up, the remainder will all line up, in spite of the random positional error (with tolerance) independently present in each pin stack.

The drilled assembly is then immersed in a hot water bath at sufficiently high temperature for the low temperature solder to melt, releasing the adhesion and allowing the components to be separated for final assembly or packaging in kit form 120. The components for each individual lock are kept together so that the components will align accurately when final assembly takes place, using these associated components. It will be apparent to the reader that if the association between components that have been drilled while temporarily assembled is disrupted, a lock assembly attempted using previously non-associated components is likely to have inaccurate shaft alignments.

It will be appreciated that in an alternative embodiment, the method omits the step of pre-forming shaft portions with undersize diameters. In this instance, using computer numerical control (CNC) techniques, the pin stack shafts are precision drilled at the specified locations into the pre-assembled temporarily adhered unit including the outer body 12 and core assembly 18. Thereafter, the unit is dissembled and the parts treated for final reassembly.

The lock product of the present disclosure presents a significantly more secure lock than believed previously known, and encourages the implementation of additional protection measures such as core retention via drill protection plates. These may be included even in a budget entry level version of the lock, optionally along with other defences such as security pins and trap pins. Such defences provide significant protective benefits against core extraction, shearing, bottom of the keyway tensioning tools and Lishie picks and decoders. Implementing a selection of the above devices leaves uncertainty in the attacker's mind as to the lock construction they are facing. For example, they would not know whether the owner had chosen the base entry level lock, being the type most often seen, or a lock containing the full repertoire of defences. The result is that even the more highly skilled attackers are obliged to expend an increased amount of time and effort to identify which features may or may not be present, prior to their committing to a given form of attack on the lock they are facing.

Some known locks include improvements in pick resistance but allow certain of their significant working parts to be visible from inside the keyway or during lock shearing attacks. Miniature cameras are available on the open market that can film the inside of the lock, allowing an attacker to cut the ‘correct’ key within seconds of accessing the lock. The locks of the embodiments of this disclosure reveal little of use to an attacker equipped with such a camera.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

As used herein, the terms “comprises,” “comprising,” “includes,” “including,” “has,” “having” or any other variation thereof, are intended to cover a non-exclusive inclusion. For example, a process, method, article, or apparatus that includes a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for an attack-resistant pin tumbler lock through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A pin tumbler lock including: A core assembly rotatably mounted within a lock body, wherein the core assembly includes cooperating first and second portions having an interface between them, the first portion being linked to an external closure member and the second portion including a keyway.

2. The lock of claim 1, wherein the first and second portions are rotatable relative to each other.

3. The lock of claim 2, wherein the second portion is partially nested within the first portion.

4. The lock of claim 3, wherein the first and second core portions are coaxially aligned.

5. The lock of claim 1 having a front end defined by a front plate spaced from the first portion, and a protection barrier against drill attack located in the body inward of the front end, the barrier being made of relatively harder material than the front plate.

6. The lock of claim 5, wherein the barrier includes hard metal rods extending radially outward from the second portion to radially traverse the lock body.

7. The lock of claim 6, wherein the rods extend through radial bores formed in the lock body into a circumferential channel in the second portion.

8. The lock of claim 7, wherein the barrier includes a hard metal plate extending radially outward from the second portion to radially traverse the lock body and surround the second portion.

9. The lock of claim 1 including a protection mechanism inhibiting axial extraction of the core assembly from the lock body.

10. The lock of claim 9, wherein the mechanism includes a ball bearing located between the lock body and the first portion.

11. The lock of claim 10, wherein the ball bearing is located between the first portion and the second portion.

12. The lock of claim 1 including a lockout mechanism that, when actuated, isolates the first portion from the second portion, the lockout mechanism being actuable by an object (other than a correct key for the lock) being inserted into the keyway and causing displacement of an end of a key pin into register with said interface between the first and second portions.

13. The lock of claim 14 including a pin stack shaft that traverses said interface between the first and second portions, and a pin stack displaceable within the shaft, said stack including a key pin and a driver pin abutting at an interface between them.

14. The lock of claim 13, wherein the first and second portions become mechanically isolated when the interface between the key pin and the driver pin is in register with the interface between the first and second portions.

15. A method of manufacture of a pin tumbler lock for mitigating pin stack shaft alignment error, the method including:
a. Associating a core component for the lock with a lock body;
b. Forming a temporary lock assembly in which the associated core component and lock body are in operative relationship;
c. Temporarily securing the associated core component and lock body of the temporary lock assembly against relative movement;
d. While said associated component and body are temporarily secured, forming a pin stack shaft that extends from the body into the core component;
e. Dissembling the temporary assembly after formation of the shaft; and
f. Maintaining association of the dissembled core component and lock body once dissembled.

16. The method of claim 15 including causing the dissembled associated components to undergo a conditioning treatment in preparation for their reassembly together into a single operative lock.

17. The method of claim 16 including assembling the lock by aligning shaft sections within the respective associated and treated body and core component.

18. The method of claim 17, wherein the core component includes first and second core portions rotatable relative to each other, the first portion being selectively mechanically isolatable from the second portion.

19. The method of claim 18, wherein the first core portion is adapted for coupling to an external locking member, and the second core portion includes a keyway and a controlled failure device rendering it sacrificial in the event of attack.

20. The method of claim 17, including providing a barrier to drilling attack, the barrier extending radially from the core component into the lock body.
